(19) United States
(12) Patent Application Publication
(10) Pub. No.: US 2001/0045883 A1
(43) Pub. Date: Nov. 29, 2001

(54) Wireless digital launch or firing system

(76) Inventors: Charles R. Holdaway, Honolulu, HI (US); Charles J. Tucker JR., Julian, CA (US)

Correspondence Address: LEIGHTON K. CHONG, OSTRAGER CHONG & FLAHERTY (HAWAII), 841 BISHOP STREET, SUITE 1200, HONOLULU, HI, 96813, US

(21) Appl. No.: 09/827,579

(22) Filed: Apr. 2, 2001

Related U.S. Application Data
(60) Provisional application No. 60/194,188, filed on Apr. 3, 2000.

(51) Int. Cl. C06C 7/00; G05B 19/00

(52) U.S. Cl. 340/5.51; 102/275.9

(57) ABSTRACT

A wireless digital launch or firing system has a transmitter unit that can transmit separate RF signals representing an “enable” code sequence and an “actuate” code sequence, and a receiver unit which decodes the “enable” code sequence to enable receipt of the “actuate” code sequence, and decodes the “actuate” code sequence to actuate launching or firing. A digital processor receives the code sequences from a receiver circuit and compares them to stored digital code sequences. A memory latch maintains a normally-off primary switch in an “on” condition when the “enable” signal is received. A normally-off secondary switch is set to an “on” condition when the “actuate” signal is received. Preferably, the RF signals are transmitted in pulse code form, and the code sequences include bits that are predetermined and stored in the hardware, bits that are selected for an individual code by the user, and bits that differentiate the “enable” from the “actuate” signal. The memory latch can be set to an indefinite “enable” period, for multiple launchings, or a timed “enable” period, for toys or single launch devices. A sequencer module can be coupled to the receiver unit for sequenced firings.

### SPECIFICATION

This U.S. patent application claims the priority of U.S. Provisional Application No. 60/194,188 of the same inventors, filed on Apr. 3, 2000, entitled “Wireless Digital Launch or Firing System for Model Rockets, Pyrotechnic or Hazardous Explosive Devices.

### TECHNICAL FIELD

This invention generally relates to a launch or firing system, and more particularly, to a system employing wireless digital circuitry for improved operation.

### BACKGROUND OF INVENTION

Many different types of radio-controlled and remote-controlled devices are commonly used for cellular telephones, portable phones, wireless PDAs, short range radio communicators, toys, remote monitors, pagers, garage door openers, etc. The limited bandwidth frequencies assigned by the Federal Communications Commission (FCC) for these devices have become so crowded in use that it is very common for signals from one transmitter device to interfere with another device intended to be operated by its own transmitter. This presents a serious problem in the use of remote controls for launching of model rockets, actuation of pyrotechnics devices, firing of hazardous explosive devices, and the like.

In the situation of commercial or entertainment use of explosives or pyrotechnic displays, firing systems for multiple devices must often be placed and readied for firing many minutes or number of hours beforehand, in order to be ready to fire on command in a timed orchestrated sequence. When such systems are armed for firing, there is an ever present danger that they may be inadvertently set off prematurely by a spurious signal from another remote-controlled device or radio device. Premature actuations of explosive devices have become unacceptably frequent in recent years, posing a serious threat of injury to explosive ordinance technicians, stagehands, actors, and spectators, as well as ruining the intended performance.

One safety firing system of interest, disclosed in U.S. Pat. No. 5,734,968 to Lay and Dean, employs a two-switch transmitter and receiver circuitry to supply power to a solenoid to actuate a launch mechanism in a fail-safe manner. When a first signal is transmitted by depressing a first switch on the transmitter, a first receiver circuit supplies a voltage through a switching circuit to a second receiver circuit to enable it to receive a second, different signal from the transmitter. When the intended second signal is transmitted by depressing a second switch on the transmitter, the second receiver circuit activates the switching circuit to pass current to the solenoid. Since the second signal that must be received is of a different frequency or wave shape, the receiver circuitry prevents a spurious signal from launching the device even if it matches one of the two required signals. Rather, the solenoid can only be actuated when the receiver circuit receives the second signal at the same time it is receiving the first signal. Both of the switches of the transmitter must be turned on in order for the two signals to be generated simultaneously and transmitted to the respective receiver circuits. A multi-unit launch system is also disclosed in which instead of the second switch on the transmitter, there are a plurality of secondary switches, each of which activates a different tuning circuit on the receiver top launch a respective one of the multiple launchers or pyrotechnic devices.

However, the above-described system has the problem that the operator must depress two switches simultaneously in order to actuate the remote-controlled device. This is particularly inconvenient in the case of large pyrotechnic displays that have many hundreds of launchers, and it is desired that the launchers be readied for firing beforehand and actuated with split-second timing in a complex timed sequence. Also, separate primary and secondary receivers are required to detect the two different signals which must be received simultaneously, thereby multiplying the cost for each launcher device, and across many units of a multiple launcher system.

### SUMMARY OF INVENTION

In accordance with the present invention, a wireless digital launch or firing system comprises:

(a) a transmitter unit have a first transmitter element for generating a first radio-frequency (RF) signal representing a first digital code sequence, and a second transmitter element for generating a second RF signal representing a second digital code sequence which is different from that of the first RF signal;

(b) a receiver unit having: (i) a receiver circuit for receiving the RF signals transmitted by the transmitter unit and demodulating them into respective digital code sequences; (ii) a digital processor for receiving the demodulated digital code sequences from the receiver circuit and comparing them to stored first and second digital code sequences, said digital processor outputting an “enable” signal if the demodulated first digital code sequence matches the stored first digital code sequence, and an “actuate” signal if the demodulated second digital code sequence matches the stored second digital code sequence; (iii) a memory latch device which maintains a normally-off primary switch in an “on” condition once the memory latch device receives the “enable” signal from the digital processor; and (iv) a normally-off secondary switch which is set to an “on” condition when it receives the “actuate” signal from the digital processor,

wherein, when both said primary and secondary switches are in the “on” condition, an electrical output is provided to actuate a launch or firing device.

In preferred embodiments, the first and second RF signals are transmitted in pulse code form. The memory latch device can be set to an indefinite “enable” period, which is useful for multi-unit launching systems that must be readied well in advance of actual firings. Alternatively, the memory latch device may be configured to maintain a short “enable” period, which is safer for use in toys or single launch or explosive devices.

The system can allow the user to set part of the digital code sequences by setting a multi-position switch which supplies predetermined bits to the digital code sequences. This would allow the user to use one transmitter to set individual codes for several single-launch devices and to fire each independently of the others. The remainder of the digital code sequences is fixed in the transmitter and receiver units by the manufacturer, to ensure that only signals transmitted by the associated transmitter unit can actuate a given receiver unit. The transmitter unit can include an LED indicator that the “Enable” button has been pushed, and the receiver can include a directional warning light faced toward the operator to indicate that the primary switch has been activated to set the unit in the “Enable” condition. A sequencer module can be coupled to the receiver unit for sequenced firings.

The system of the invention provides certain advantages and improvements over the prior devices. The use of a digital processor allows the two, or many, different signals of the same frequency or type to be demodulated and compared by the same receiver circuit and processor, thereby providing a simpler configuration and saving on fabrication and assembly costs. This can result in significant savings when the system is used for multiple firings. The memory latch device allows the system to be set to the “enable” condition, thereby avoiding the need to have the operator depress both transmitter switches at the same time. The memory latch device can also be set to the “enable” condition for a timed period, which provides greater safety against inadvertent triggering if the operator or another person decides to approach the launch device after it had been set to the “enable” condition.

Other objects, features, and advantages of the present invention will be explained in the following detailed description of the invention having reference to the appended drawings.

### BRIEF DESCRIPTION OF DRAWINGS

FIG. 1 is a schematic diagram of a transmitter unit for a wireless digital launch or firing system in accordance with the invention.

FIG. 2 is a schematic diagram of a receiver unit for the wireless digital launch or firing system.

FIG. 3 is a timing diagram illustrating the timing sequence for the first and second digital code sequences used in the system.

FIG. 4 is a detailed diagram illustrating the first and second digital code sequences used in the system.

FIG. 5 is a circuit diagram of an embodiment of the receiver unit which provides an indefinite enable period.

FIG. 6 is a circuit diagram of another embodiment of the receiver unit which provides a timed enable period.

FIG. 7 is a circuit diagram of an embodiment of the transmitter unit for the system.

FIG. 8 is a circuit diagram of a sequencer module for handling multiple launch or firing devices.

### DETAILED DESCRIPTION OF INVENTION

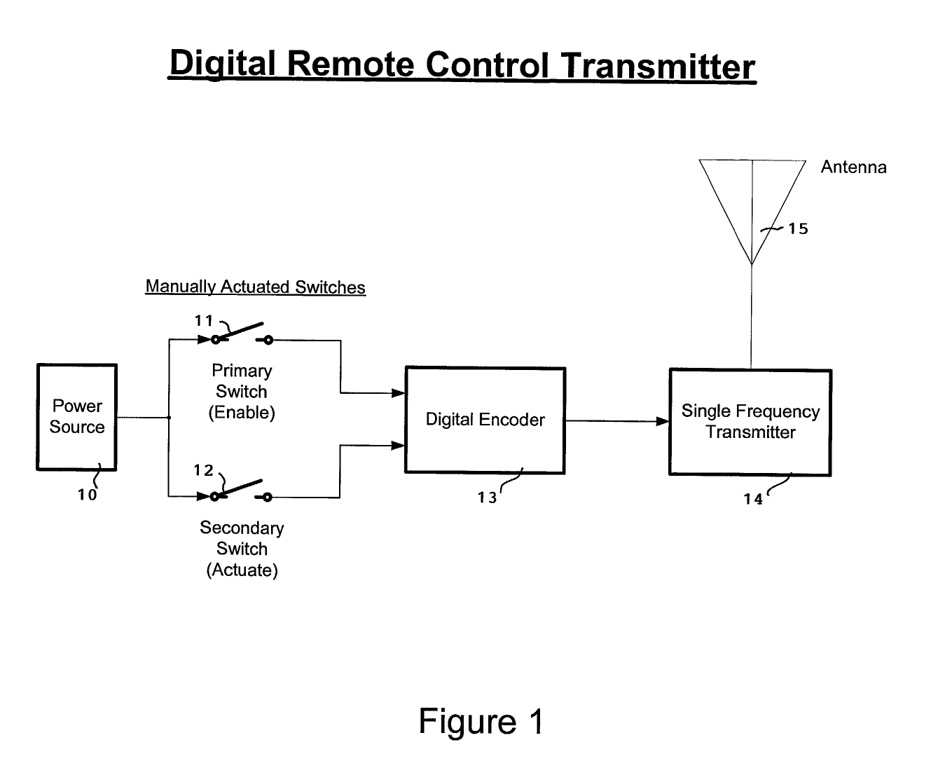

Referring to FIG. 1, a transmitter unit for a wireless digital launch or firing system in accordance with the invention is shown schematically having a power source 10, such as a battery, a primary (Enable) switch 11, a secondary (Actuate) switch 12, a digital encoder 13, a single-frequency transmitter 14, and an antenna 15. Closing the Enable switch 11 sends a voltage signal to one input of the digital encoder 13 to generate a first digital code sequence representing a valid Enable signal, which is converted to a corresponding radio-frequency (RF) signal in pulse code form for transmission via antenna 15. The conversion of a digital code signal into pulse code form by AM modulation between carrier On and Off states is well known to those skilled in this field and not described in further detail herein. Similarly, closing the Actuate switch 12 sends a voltage signal to another input of the digital encoder 13 to generate a second digital code sequence representing a valid Actuate signal in pulse code form via antenna 15. The first and second digital code sequences are fixed by the manufacturer in the digital encoder. As described further below, part of the digital code sequences may be selected by the operator as a safety feature or to allow assignment of individual codes to separate firing devices.

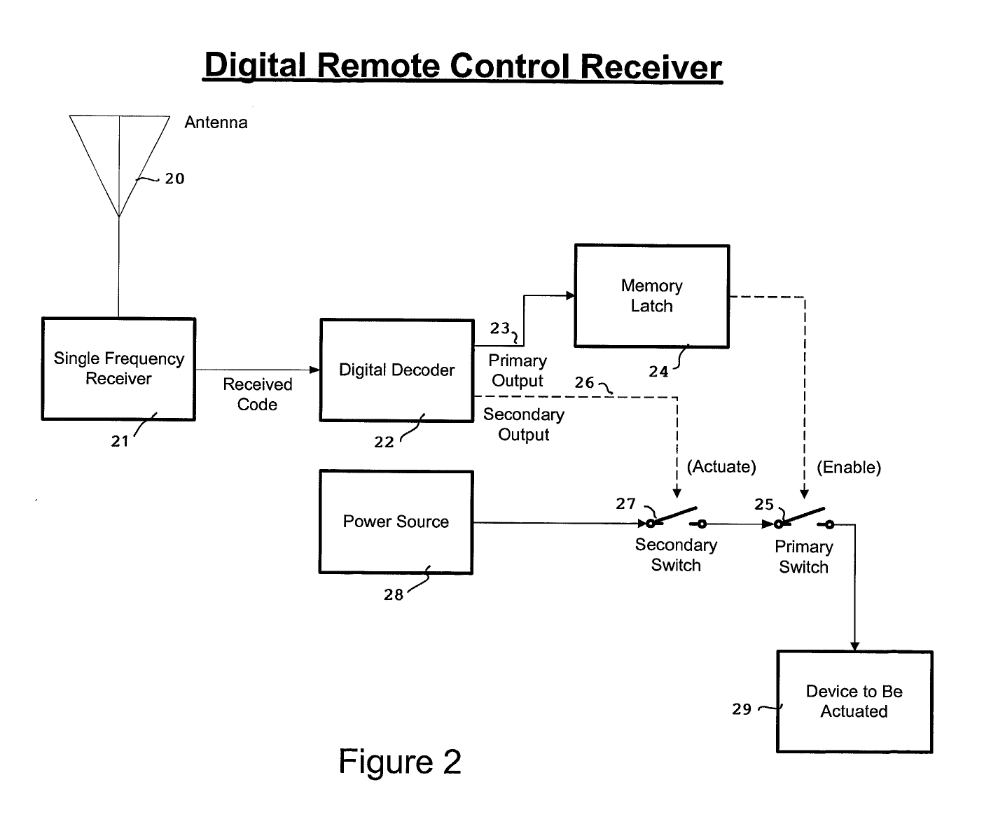

Referring to FIG. 2, a receiver unit for the system is shown schematically having an antenna 20 for receiving the Enable and Actuate signals transmitted from the transmitter unit, and a single-frequency receiver 21 which converts the pulse code RF signals into their corresponding digital code sequences. A digital processor or decoder 22 compares the received codes to stored (authorized) codes and provides a primary output of an Enable signal 23 when a valid Enable input signal is received, and a secondary output of an Actuate signal 26 when a valid Actuate input signal is received. The Enable output signal is provided to a memory latch 24 which then sets and maintains a normally-off primary switch 25 in an “on” condition. The Actuate output signal is provided to set a normally-off secondary switch 27 in an “on” condition. When both primary and secondary switches are in the “on” condition, an electrical connection is formed from a power source 28 to a launching or explosive device 29 so that it is actuated.

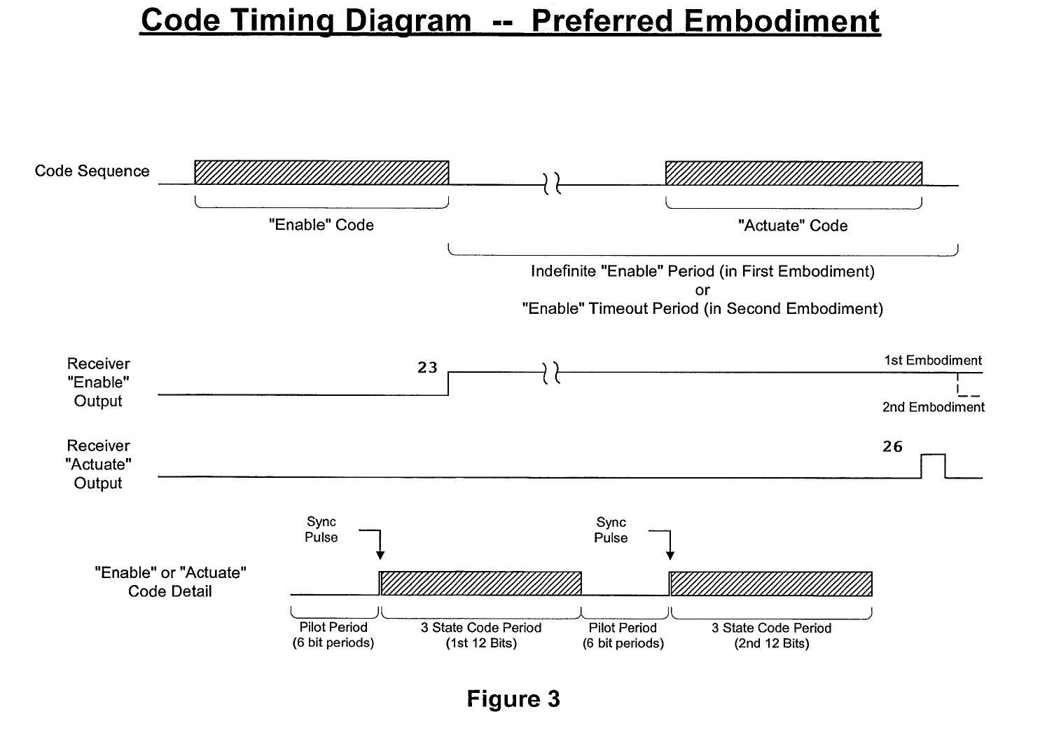

In FIG. 3, the timing of the Enable and Actuate signals is illustrated. In the first line, the Enable code sequence is shown transmitted first in time, followed by the Actuate code sequence. In the second line, the Enable code sequence results in the receiver issuing the Enable output 23 to set the primary switch 25 in the Enable condition. In one embodiment, the Enable condition is an indefinite period. In another embodiment, the Enable condition is limited to a timed period as an additional safety precaution. In the third line, the Actuate code sequence results in the Actuate output 26 to set the secondary switch 27 in the Actuate condition. In the fourth line, the code sequence for the “Enable” or “Actuate” condition is shown as two successive code trains of the same 12-bits each. The preferred format is a 6-bit pilot period of no signal, followed the first 12-bit code period led by a Sync pulse, then another 6-bit pilot period, then the second 12-bit code period. This format, used by Holtek Semiconductor Inc., of Taiwan, Republic of China, allows the start of the code periods to be reliably detected by the no-signal pilot period and leading Sync pulse. The 2 successive code periods with a total of 24 bits to be matched by the receiver reduce the risk of error to a very small probability.

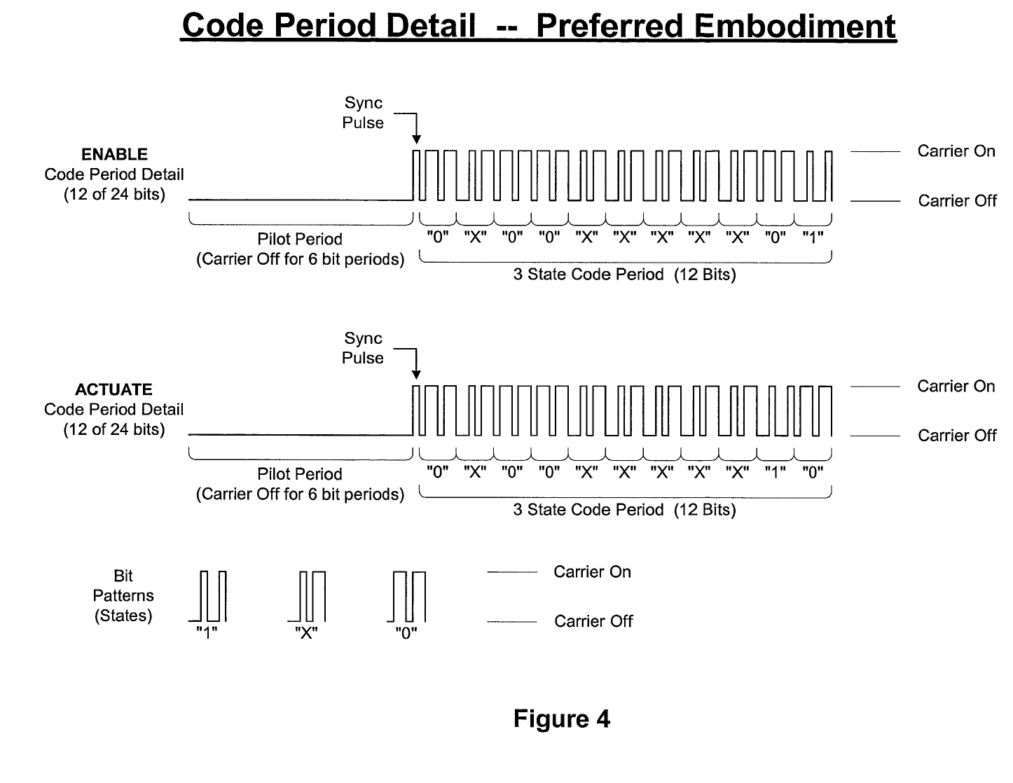

In FIG. 4, the Enable and Actuate code signals are illustrated in more detail. In the preferred format, a 3-State encoding system is used in which sequences of different pulse widths designate “1”, “0”, and “X” bits. In the first line, the Enable input code is shown having a train of 10 bits led by the Sync pulse and 2 ending bits. Similarly, the Actuate input code is shown having a train of 10 bits led by the Sync pulse and 2 ending bits. For the two ending bits, a “0” bit in the 11th-bit position (followed by a “1” bit) indicates that it was transmitted by the Enable switch of the transmitter, while a “0” bit in the 12th-bit position (preceded by a “1” bit) indicates that it was transmitted by the Actuate switch of the transmitter.

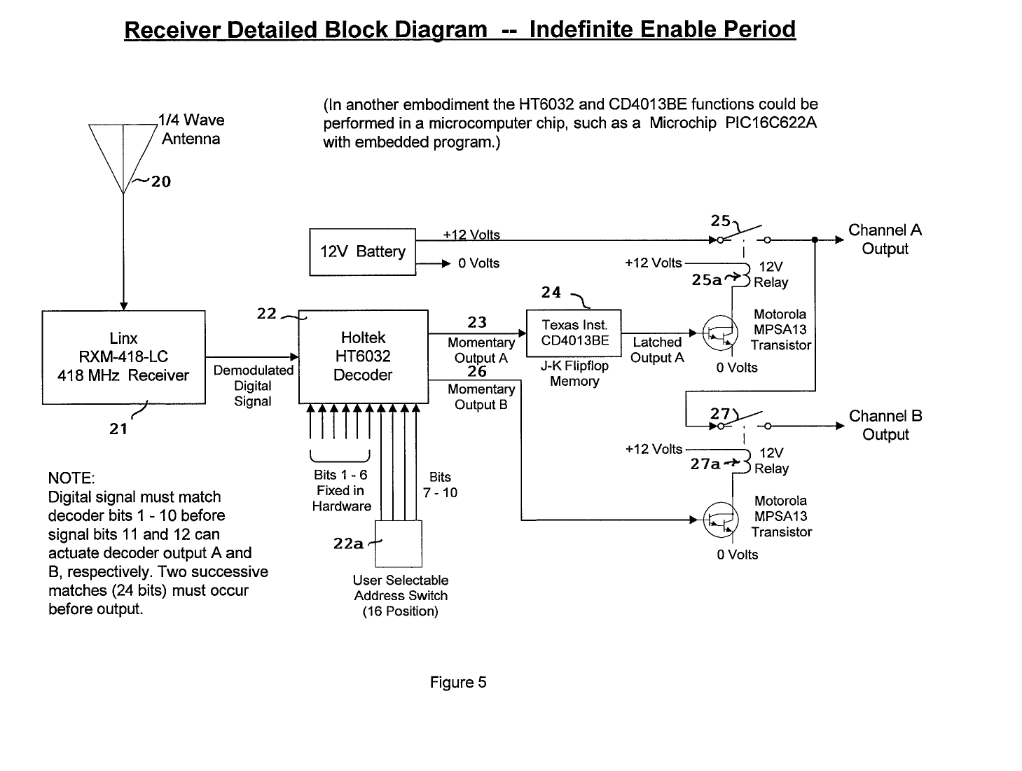

In FIG. 5, a circuit diagram illustrates the preferred components of the receiver unit which provides an indefinite Enable period. The antenna 20 is a ¼ wave antenna suitable to receiving an RF signal in pulse code format. The receiver 21 is a Linx RXM-418-LC 418 MHz receiver, distributed by Linx Technologies, Inc., of Grants Pass, Oreg. The digital decoder 22 is a Holtek HT6032 decoder which receives the 12-bit demodulated code signals and compares them to stored code sequences. The stored code sequences have bits 1-6 fixed by the manufacturer in hardware, bits 7-10 selectable by the user by setting a position switch 22a in one of 16 positions (4 binary bits), and ending bits 11-12 indicating the “Enable” or “Actuate” condition. The decoder function can also be implemented using a microprocessor which is programmed to perform the comparison and signal output function. Use of a microprocessor would allow the system to be readily programmed for different signal formats and code sequences.

If the Enable input code matches the stored code, the Enable output signal 23 is provided to the memory latch device 24, which consists of a flip-flop such as a TI CD4013BE, distributed by Texas Instruments Corp., of Dallas, Tex. The output of the flip-flop is latched to the input of a transistor such as an MPSA13 transistor, distributed by Motorola Inc., of Schaumberg, Ill. This results in activation of a relay 25a to hold the primary switch 25 in the “on” condition. The “on” condition may also be used to provide a Channel A output used for other purposes, such as an external warning light (positioned to face toward the operator in the intended environment of use). If the Actuate input code matches its corresponding stored code, the Actuate output signal 26 activates the transistor and relay 27a to set the secondary switch 27 in the “on” condition. Closing of both switches 25 and 27 results in the power source (battery) 28 being connected to provide the Channel B output which is used to actuate the launch or firing device.

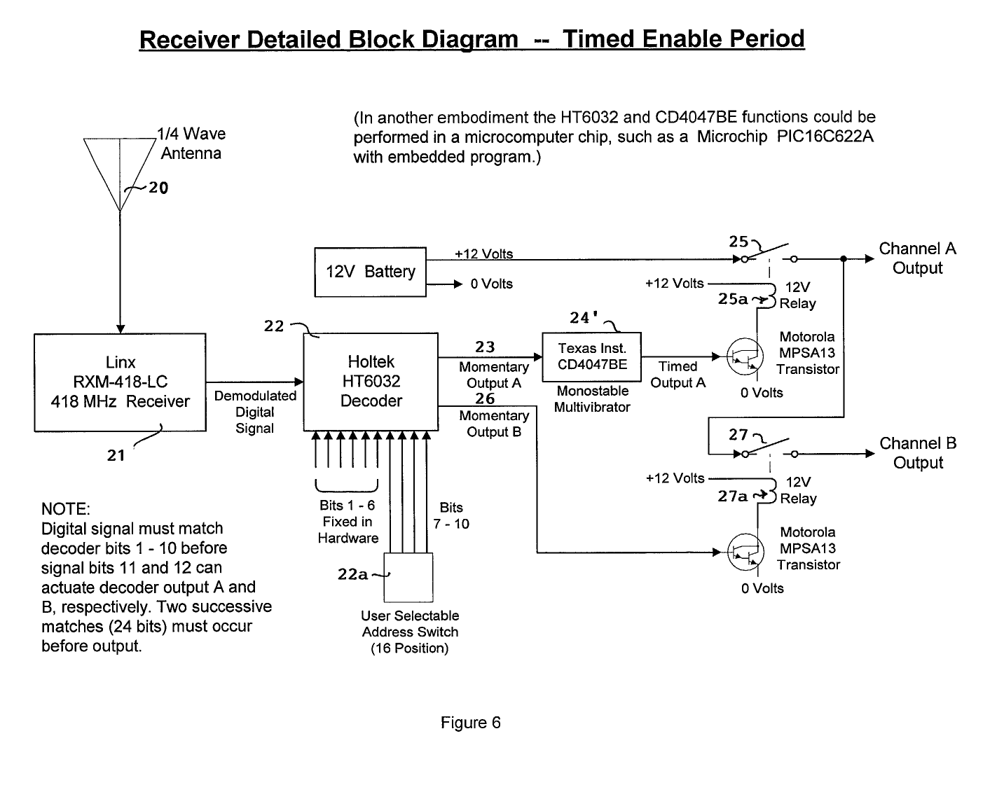

In FIG. 6, a circuit diagram illustrates the components of a receiver unit which provides a timed Enable period. In this version, a monostable vibrator 24′ such as a TI CD4047BE provides a timed output to the transistor and relay 25a for the primary switch 25. After it times out, the relay 25a is deactivated and the primary switch returns to the “off” condition. The firing device cannot be actuated until the Enable switch of the transmitter unit is activated again. The other components of the receiver unit are otherwise the same.

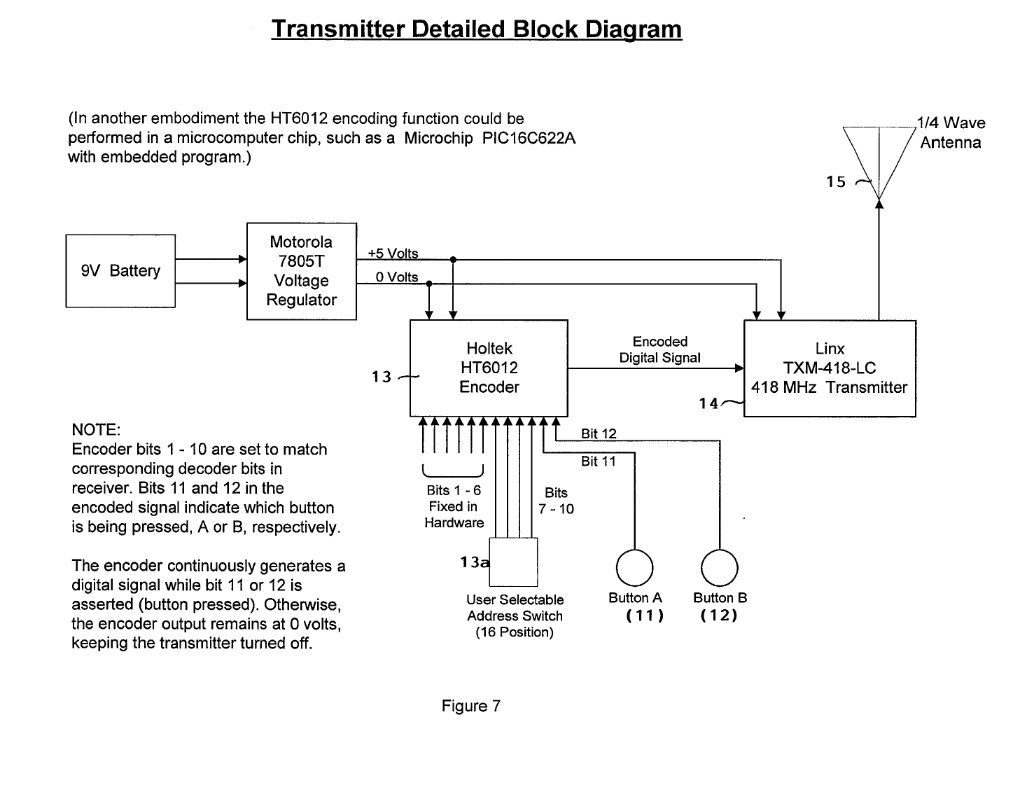

In FIG. 7, a circuit diagram illustrates the preferred components of the transmitter unit. The digital encoder 13 is a Holtek HT6012 encoder. The encoder 13 generates a signal when Button A or Button B is pressed. When Button A is pressed, the output code signal has bits 1-6 determined as fixed by the manufacturer in hardware, bits 7-10 determined by the individually assigned code selected by the user, a “0” bit in the 11th-bit position, and a “1” bit in the 12th-bit position. When Button B is pressed, the output code signal has bits 1-6 determined in hardware, bits 7-10 determined by the code selected by the user, a “1” bit in the 11th-bit position, and a “0” bit in the 12th-bit position. The 6 bits fixed by the manufacturer are shown as being the same for both the Enable and Actuate signals, so that the associated transmitter signals will be recognized only by a receiver which has the same stored codes fixed by the manufacturer. However, they may also be set up as two codes that are variations of the other, so as to further differentiate between the Enable and Actuate code. The user selected bits 7-10 are generated according to the user selectable address switch 13a. The encoder 13 continuously generates a code signal while Button A or B is pressed. Otherwise, the encoder output remains at 0 volts, keeping the transmitter turned off. The generated code sequences are modulated into pulse code form by the transmitter 14 which may be a Linx TXM-418-LC transmitter.

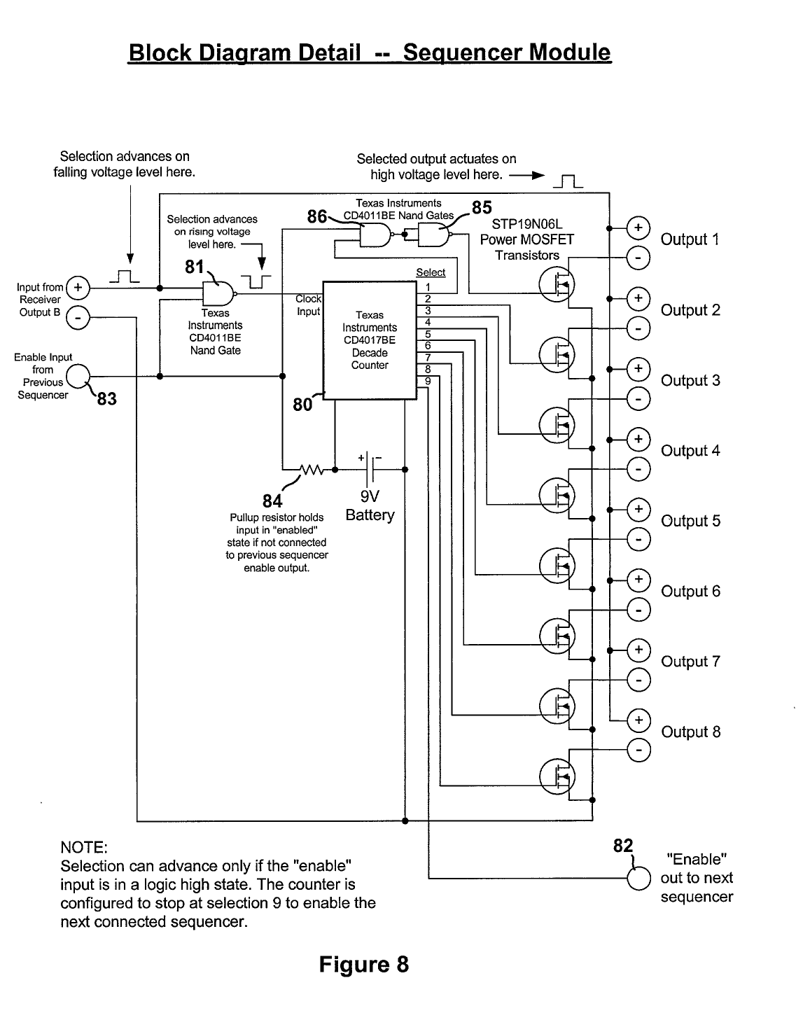

The invention can be readily adapted to a system for multiple launchings or firings by providing a sequencer module to receive the Channel B output from the receiver unit in FIG. 5 or 6. Referring to FIG. 8, the sequencer unit has a number of outputs (e.g., Output 1 . . . Output 8) controlled by a sequence counter 80 such as a TI CD4017BE decade counter. After the Enable signal has been received and placed the receiver unit in the Enable condition, each receipt of an Actuate signal by the receiver unit results in transmission of an Actuate output pulse at the Channel B output. At the sequencer, each Actuate pulse is transmitted to the “+” side of the Output terminals. It is also transmitted via a NAND gate 81 (such as TI CD4011BE) to the clock input to the counter 80, which shifts an enabled output to each respective power MOSFET transistor for a respective one of the Outputs (1, 2, . . . , 9) in sequence so as to provide an output current at the “−” side of the respective Output terminal. The last output (9) of the counter 80 is an Enable output 82 that can be provided to an Enable input 83 of a next sequencer. The Enable input 83 from a previous sequencer is used to set the first Output 1 of the next sequencer in the enabled condition by coupling it with the first output of the counter 80 through a NAND gate 86 inverted through a second NAND gate 85 to the power MOSFET transistor for Output 1. Selection of each next output can only advance if the “Enable” input is in a high logic state. One or more other sequence modules may thus be coupled together in cascade fashion. A pullup resistor 84 is used to hold the low input of the NAND gate in the “enabled” state for the first sequencer module that is not connected to a previous sequencer.

A detailed description of operation of an exemplary embodiment of the wireless digital launch or firing system will now be described. The hand-held remote control transmitter has a typical range of 60 yards (line of sight operation) to the associated receiver unit. Inscriptions on the transmitter panel can be etched with luminescent paint to facilitate use of the transmitter in a dark environment. The transmitter's Enable and Actuate outputs are digitally encoded and amplitude modulated on a single carrier frequency of 418 MHz. This frequency is controlled by a SAW (surface acoustic wave) device for exceptional stability. No alignment or tuning procedures are ever required to maintain optimum performance. The modulated RF output occurs continuously while one of the two momentary transmit Buttons A and B is depressed. The RF signal is radiated by a quarter-wave flexible whip antenna which screws onto the top end of the transmitter box.

A keyed, safety locking switch is provided on the transmitter panel with two positions, “Safe” and “Xmtr Enabled”. In the “Safe” position, no RF output occurs even if a button is pressed. In the “Xmtr Enabled” position, modulated RF output occurs continuously while a button is pressed. Whether transmitting or not, a red warning indicator near the switch flashes whenever the switch is in its “Xmtr Enabled” position and the battery voltage is above the low battery detect threshold. The key may be removed from the switch in either position.

The Buttons A and B are snap action dome switches under a sealed overlay, labeled “Fire A” and “Fire B”, respectively. They have a high spring constant which requires a firm depression for actuation, decreasing the likelihood of accidental depression. The enabled transmitter can be kept in a shirt or jacket pocket without fear of accidental button depression. An LED indicator may be placed on the transmitter panel to indicate when the “Fire A” button has been pressed. It will light even if the battery voltage is below the low battery detect threshold. As an additional safety feature a directional warning light visible in direct sunlight may be provided on the receiver and positioned to face toward the operator at a firing booth or console. The warning light is lit when the “Enable” code has been received and an “Enable” output has been issued by the receiver unit.

A 16-position miniature rotary switch is provided to allow the user to set an individual code or for firing a number of separate devices. The user-selectable switch can be hidden or recessed in an interior panel of the transmitter. The transmitter will only actuate receivers whose corresponding switch has been set to the same position as the transmitter. Thus, multiple transmitters may be used to actuate different selected receivers even though all operate on the same frequency.

A principal safety goal is to ensure that data communication errors due to radio interference or to insufficient signal strength due to low battery, exceeding specified range, or conductive objects in the signal path will result in failure of intentional actuation rather than unintended actuation. This goal is achieved by transmitting a 12 bit, 3-state, code repeatedly while a transmitter button is depressed. Ten of those bits must match the pattern expected by the receiver, and the other two bits indicate which button (A or B) has been pressed. Two successive received 12-bit patterns must be identical before an actuation can occur. Thus, there is one chance in 3²⁰ (or a probability of 0.000000000287) of an actuation occurring due to reception of a random signal. Though the probability of unintended actuation is extremely small, it cannot be guaranteed to be zero. Therefore, it is important that the user not enable the receiver until all persons who might be harmed by accidental actuation are in a safe area. Additional protection is offered by use of a bit pattern that cannot produce a match in the receiver if a synchronization error occurs, and by selection of 418 MHz as the operating frequency. This frequency is sparsely used only by low power transmitters with a maximum range of approximately 100 yards. It is not commonly used by auto security systems, garage door openers, radio control models, cordless telephones, wireless microphones, or two way communications equipment.

It is understood that many modifications and variations may be devised given the above description of the principles of the invention. It is intended that all such modifications and variations be considered as within the spirit and scope of this invention, as defined in the following claims.

We claim:

1. A wireless digital launch or firing system comprising:
(a) a transmitter unit having a first transmitter element for generating a first radio-frequency (RF) signal representing a first digital code sequence, and a second transmitter element for generating a second RF signal representing a second digital code sequence which is different from that of the first RF signal;
(b) a receiver unit having: (i) a receiver circuit for receiving the RF signals transmitted by the transmitter unit and demodulating them into respective digital code sequences; (ii) a digital processor for receiving the demodulated digital code sequences from the receiver circuit and comparing them to stored first and second digital code sequences, said digital processor outputting an “enable” signal if the demodulated first digital code sequence matches the stored first digital code sequence, and an “actuate” signal if the demodulated second digital code sequence matches the stored second digital code sequence; (iii) a memory latch device which maintains a normally-off primary switch in an “on” condition once the memory latch device receives the “enable” signal from the digital processor; and (iv) a normally-off secondary switch which is set to an “on” condition when it receives the “actuate” signal from the digital processor,
wherein, when both said primary and secondary switches are in the “on” condition, an electrical output is provided to actuate a launch or firing device.

2. A system according to claim 1, wherein the RF signals transmitted by the transmitter are in pulse code form and modulated on a single frequency.

3. A system according to claim 1, wherein the RF signal represents digital code sequences having a first plurality of bits which are predetermined and stored in the transmitter and receiver units.

4. A system according to claim 2, wherein the digital code sequences have a second plurality of bits which are determined by user selection.

5. A system according to claim 2, wherein the digital code sequences have one bit determined by activation of the first transmitter element and another bit determined by activation of the second transmitter element.

6. A system according to claim 1, wherein the transmitter unit includes a digital encoder, the first transmitter element as a primary switch which provides one input to the digital encoder, and the second transmitter element as a secondary switch which provides another input to the digital encoder.

7. A system according to claim 6, wherein the first transmitter element is a first button switch which provides a one-bit input to the digital encoder when depressed, and the second transmitter element is a second button switch which provides another one-bit input to the digital encoder when depressed.

8. A system according to claim 2, wherein the receiver circuit demodulates the single-frequency pulse code signals and provides the demodulated code signals to a digital decoder which compares them with stored digital code sequences.

9. A system according to claim 8, wherein the demodulated and stored digital code sequences have a first plurality of bits which are predetermined and stored in the transmitter and receiver units.

10. A system according to claim 9, wherein the digital code sequences have a second plurality of bits which are determined by user selection.

11. A system according to claim 9, wherein the digital code sequences have one bit determined by activation of the first transmitter element and another bit determined by activation of the second transmitter element.

12. A system according to claim 10, wherein said second plurality of bits is determined by user setting of a selectable position switch which supplies bits based on the selected position for the digital code sequences.

13. A system according to claim 1, wherein said memory latch device provides an indefinite “enable” period.

14. A system according to claim 1, wherein said memory latch device provides a timed “enable” period.

15. A system according to claim 1, wherein the receiver unit includes an external warning light to indicate that the primary switch has been closed to set the receiver unit in the “enable” condition.

16. A system according to claim 1, further comprising a sequencer module for providing a plurality of outputs in sequence for actuating a plurality of launch or firing devices, said sequencer module receiving an electrical output from said system as an “actuate” input signal to provide one of the plurality of sequencer outputs.

17. A system according to claim 16, wherein said sequencer module includes as a last one of its plurality of outputs an “enable” output signal which is provided as an “enable” input signal to enable actuation of a next sequencer module connected to said first-described sequencer module, and said next sequencer module receiving an electrical output from said system as an “actuate” input signal to provide one of the plurality of sequencer outputs.

18. A wireless digital launch or firing device comprising:
(a) a receiver circuit for receiving a first radio-frequency (RF) signal representing a first digital code sequence, a second RF signal representing a second digital code sequence which is different from that of the first RF signal, and demodulating them into respective digital code sequences;
(b) a digital processor for receiving the demodulated digital code sequences from the receiver circuit and comparing them to stored first and second digital code sequences, said digital processor outputting an “enable” signal if the demodulated first digital code sequence matches the stored first digital code sequence, and an “actuate” signal if the demodulated second digital code sequence matches the stored second digital code sequence;
(c) a memory latch device which maintains a normally-off primary switch in an “on” condition once the memory latch device receives the “enable” signal from the digital processor; and
(d) a normally-off secondary switch which is set to an “on” condition when it receives the “actuate” signal from the digital processor,
wherein, when both said primary and secondary switches are in the “on” condition, an electrical output is provided to actuate a launch or firing device.

19. A device according to claim 18, further comprising a sequencer module for providing a plurality of outputs in sequence for actuating a plurality of launch or firing devices, said sequencer module receiving an electrical output from said device as an “actuate” input signal to provide one of the plurality of sequencer outputs.

20. A method of wireless digital launching or firing comprising:
(a) receiving a first radio-frequency (RF) signal representing a first digital code sequence, a second RF signal representing a second digital code sequence which is different from that of the first RF signal, and demodulating them into respective digital code sequences;
(b) receiving the demodulated digital code sequences and comparing them to stored first and second digital code sequences, and outputting an “enable” signal if the demodulated first digital code sequence matches the stored first digital code sequence, and an “actuate” signal if the demodulated second digital code sequence matches the stored second digital code sequence;
(c) maintaining a normally-off primary switch in an “on” condition once the “enable” signal is output; and
(d) setting a normally-off secondary switch to an “on” condition when the “actuate” signal is output,
(e) providing an electrical output to actuate a launch or firing device when both said primary and secondary switches are in the “on” condition.
